(19) United States
(12) Patent Application Publication
(10) Pub. No.: US 2026/0070202 A1
(43) Pub. Date: Mar. 12, 2026

(54) GAS SPRING-POWERED FASTENER DRIVER

(71) Applicant: MILWAUKEE ELECTRIC TOOL CORPORATION, Brookfield, WI (US)

(72) Inventors: Kirat S. Mokha, Milwaukee, WI (US); Mitchell A. Ellena, West Allis, WI (US); Noah P. Seiler, Milwaukee, WI (US); Lokeshwaran Rajendran, West Allis, WI (US); Mark C. Hughes, Waukesha, WI (US); David C. Graf, Greendale, WI (US)

(21) Appl. No.: 19/321,673

(22) Filed: Sep. 8, 2025

Related U.S. Application Data
(60) Provisional application No. 63/692,268, filed on Sep. 9, 2024.

(51) Int. Cl. B25C 1/04; B25C 1/00; B25C 1/06

(52) U.S. Cl. CPC B25C 1/047; B25C 1/008; B25C 1/06

(57) ABSTRACT

A powered fastener driver including: a rotary lifter rotatably supported within the housing and configured to sequentially engage the plurality of teeth to move a driver blade from a bottom-dead-center position toward a top-dead-center position; a drive unit configured to provide torque to the rotary lifter, causing it to rotate; a nosepiece defining a fastener driving channel, the fastener driving channel extending along a driving axis of the driver blade; a workpiece contact element movable relative to the nosepiece between an extended position and a retracted position; a sensor assembly including a first inductive sensor configured to detect a position of the workpiece contact element in one of the extended position or the retracted position; and a second inductive sensor configured to detect an angular position of the rotary lifter, wherein the first inductive sensor and the second inductive sensor are on opposite sides of the rotary lifter.

### CROSS-REFERENCE TO RELATED APPLICATIONS

This application claims priority to U.S. Provisional Patent Application No. 63/692,268 filed on Sep. 9, 2024, the entire contents of which are incorporated herein by reference.

### FIELD OF THE DISCLOSURE

The present disclosure relates to powered fastener drivers, and more specifically to gas spring-powered fastener drivers.

### BACKGROUND OF THE DISCLOSURE

There are various fastener drivers known in the art for driving fasteners (e.g., nails, tacks, staples, etc.) into a workpiece. These fastener drivers operate utilizing various means known in the art (e.g., compressed air generated by an air compressor, electrical energy, a flywheel mechanism, etc.) to drive a driver blade from a top-dead-center position toward a bottom-dead-center position to strike a fastener and drive the fastener into a workpiece.

### SUMMARY OF THE DISCLOSURE

The present disclosure provides, in one aspect, a powered fastener driver including a housing and a cylinder within the housing. The cylinder containing a pressurized gas. The powered fastener driver also includes a piston within the cylinder and moveable from a top-dead-center position to a bottom-dead-center position and a driver blade moveably coupled to the piston for driving a fastener into a workpiece. The driver blade having a plurality of teeth. The powered fastener driver also includes a lifting assembly configured to sequentially engage the teeth to move the driver blade from the bottom-dead-center position toward the top-dead-center position and a nosepiece defining a fastener driving channel from which consecutive fasteners from a magazine are driven. The fastener driving channel extending along a driving axis of the driver blade. The powered fastener driver also includes a workpiece contact element movable relative to the nosepiece between an extended position and a retracted position, a sensor target coupled for movement with the workpiece contact element, and an inductive sensor configured to detect the sensor target to determine a position of the workpiece contact element in one of the extended position or the retracted position.

In some aspects, the techniques described herein relate to a powered fastener driver including: a housing; a cylinder within the housing, the cylinder containing a pressurized gas; a piston within the cylinder and moveable from a top-dead-center position to a bottom-dead-center position; a driver blade moveably coupled to the piston for driving a fastener into a workpiece, the driver blade having a plurality of teeth; a rotary lifter rotatably supported within the housing and configured to sequentially engage the plurality of teeth to move the driver blade from the bottom-dead-center position toward the top-dead-center position; a drive unit configured to provide torque to the rotary lifter, causing it to rotate; a nosepiece defining a fastener driving channel from which consecutive fasteners from a magazine are driven, the fastener driving channel extending along a driving axis of the driver blade; a workpiece contact element movable relative to the nosepiece between an extended position and a retracted position; a first sensor target coupled for movement with the workpiece contact element; a first sensor positioned forward of the rotary lifter and configured to detect the first sensor target to determine a position of the workpiece contact element in one of the extended position or the retracted position; a second sensor target coupled for co-rotation with the rotary lifter; and a second sensor positioned rearward of the rotary lifter and configured to detect an angular position of the rotary lifter.

In some aspects, the techniques described herein relate to a powered fastener driver including: a housing; a cylinder within the housing, the cylinder containing a pressurized gas; a piston within the cylinder and moveable from a top-dead-center position to a bottom-dead-center position; a driver blade moveably coupled to the piston for driving a fastener into a workpiece, the driver blade having a plurality of teeth; a rotary lifter rotatably supported within the housing and configured to sequentially engage the plurality of teeth to move the driver blade from the bottom-dead-center position toward the top-dead-center position; a drive unit configured to provide torque to the rotary lifter, causing it to rotate; a nosepiece defining a fastener driving channel from which consecutive fasteners from a magazine are driven, the fastener driving channel extending along a driving axis of the driver blade; a workpiece contact element movable relative to the nosepiece between an extended position and a retracted position; a sensor assembly including a first inductive sensor configured to detect a position of the workpiece contact element in one of the extended position or the retracted position; a second inductive sensor configured to detect an angular position of the rotary lifter, wherein the first inductive sensor and the second inductive sensor are on opposite sides of the rotary lifter.

In some aspects, the techniques described herein relate to a powered fastener driver including: a housing; a cylinder within the housing, the cylinder containing a pressurized gas; a piston within the cylinder and moveable from a top-dead-center position to a bottom-dead-center position; a driver blade moveably coupled to the piston for driving a fastener into a workpiece, the driver blade having a plurality of teeth; a frame at least partially within the housing; a rotary lifter rotatably supported by the frame and configured to sequentially engage the plurality of teeth to move the driver blade from the bottom-dead-center position toward the top-dead-center position; a drive unit configured to provide torque to the rotary lifter, causing it to rotate; a lifter sensor assembly configured to detect an angular position of the rotary lifter, the lifter sensor assembly including: an inductive sensor coupled to the frame between the drive unit and the rotary lifter, and a sensor target coupled for co-rotation with the rotary lifter.

Other features and aspects of the disclosure will become apparent by consideration of the following detailed description and accompanying drawings.

### BRIEF DESCRIPTION OF THE DRAWINGS

FIG. 1 is a perspective view of a powered fastener driver in accordance with an embodiment of the present disclosure.

FIG. 2 is a perspective view of the powered fastener driver of FIG. 1, with a portion of a housing hidden.

FIG. 3 is a cross-sectional view of the powered fastener driver, taken along section line 3--3 in FIG. 1.

FIG. 4 is another cross-sectional view of the powered fastener driver taken along section line 4--4 in FIG. 1.

FIG. 5A is a perspective exploded view of a lifter sensor bracket and a lifter sensor of the powered fastener driver of FIG. 1.

FIG. 5B is another perspective exploded view of a frame of the lifter sensor bracket and a lifter sensor of the powered fastener driver of FIG. 1

FIG. 6 is a perspective view of a portion of the powered fastener driver of FIG. 1, illustrating a workpiece contact element and a workpiece contact element sensor.

FIG. 7 is a perspective view of a portion of the powered fastener driver of FIG. 1, illustrating a nosepiece with the workpiece contact element and the workpiece contact element sensor.

FIG. 8 is a perspective exploded view of the workpiece contact element sensor and a workpiece contact element sensor housing.

FIG. 8A is a perspective view of a workpiece contact element sensor according to another embodiment.

FIG. 8B is schematic of an operative range of the workpiece contact element sensor of FIG. 8A.

FIG. 9 is a schematic view of a control system of the powered fastener driver of FIG. 1.

FIG. 10 is a perspective view of a powered fastener driver in accordance with an embodiment of the present disclosure.

FIG. 11 is a perspective view of the powered fastener driver of FIG. 10, with a portion of a housing hidden.

FIG. 12 is a perspective view of a powered fastener driver in accordance with an embodiment of the present disclosure.

FIG. 13 is a perspective view of the powered fastener driver of FIG. 12, with a portion of a housing hidden.

FIG. 14 is a perspective view of a nosepiece, a workpiece contact element, and a depth adjustment mechanism of the powered fastener driver of FIG. 12.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

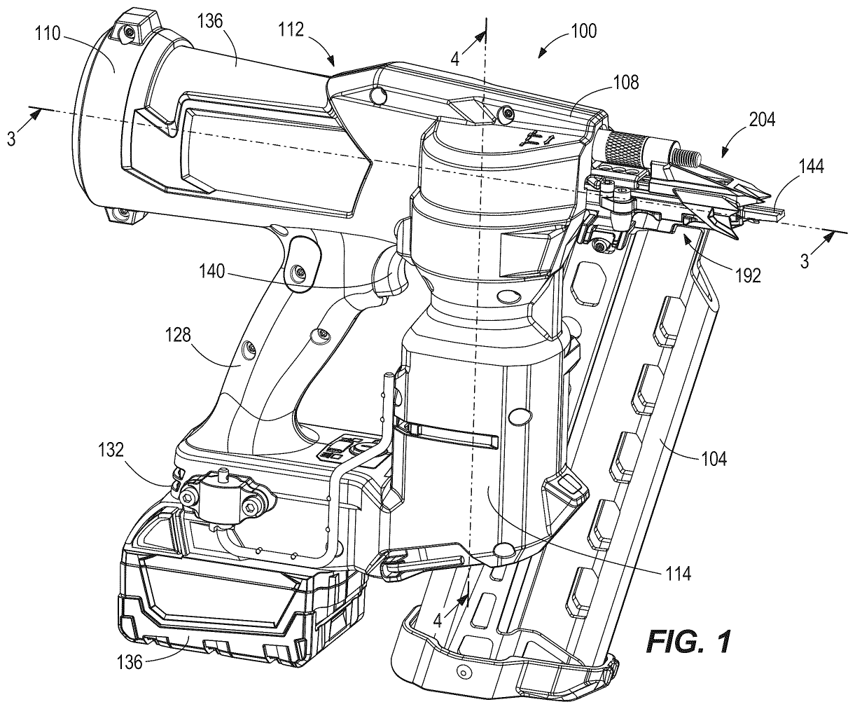

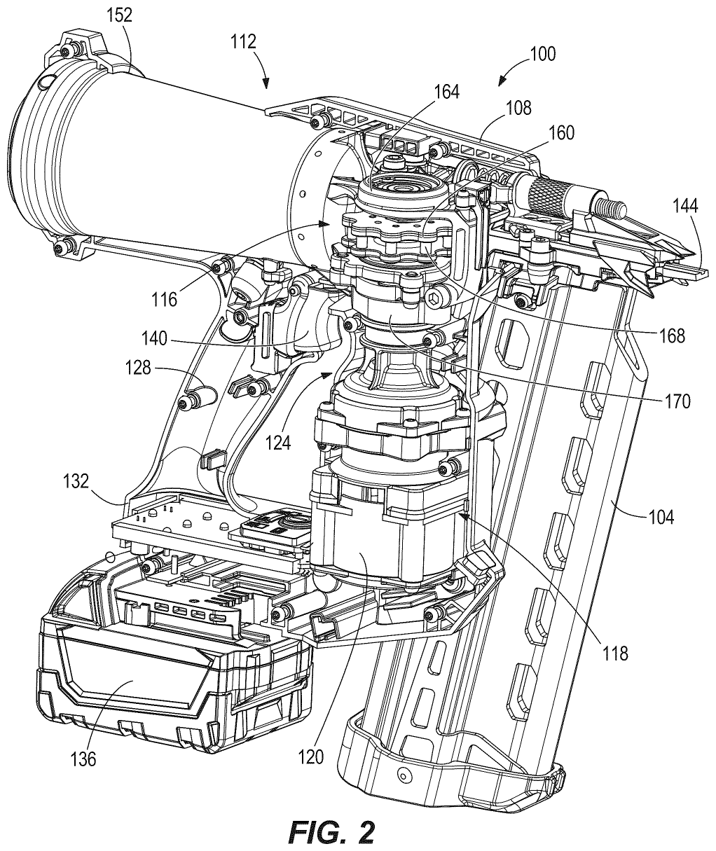

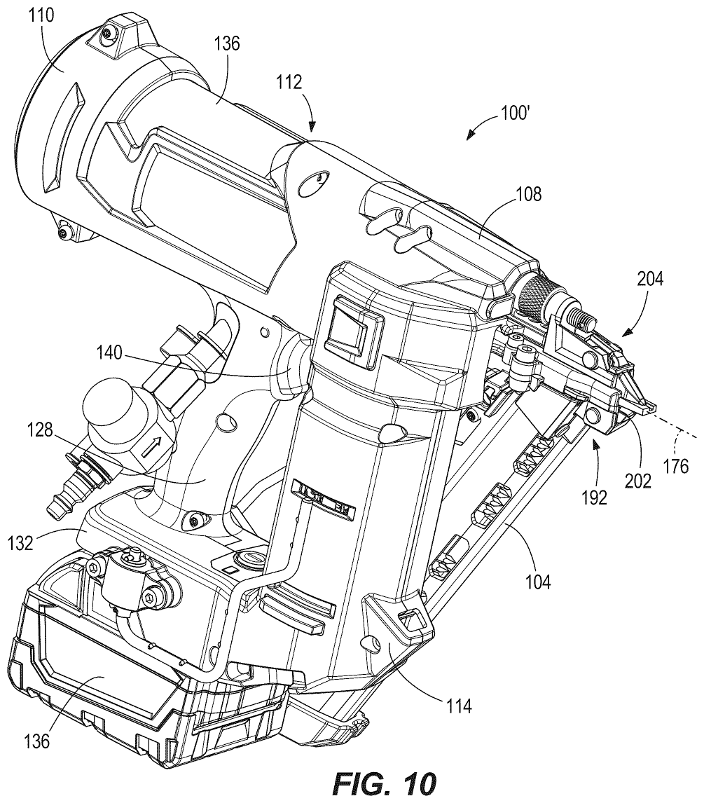

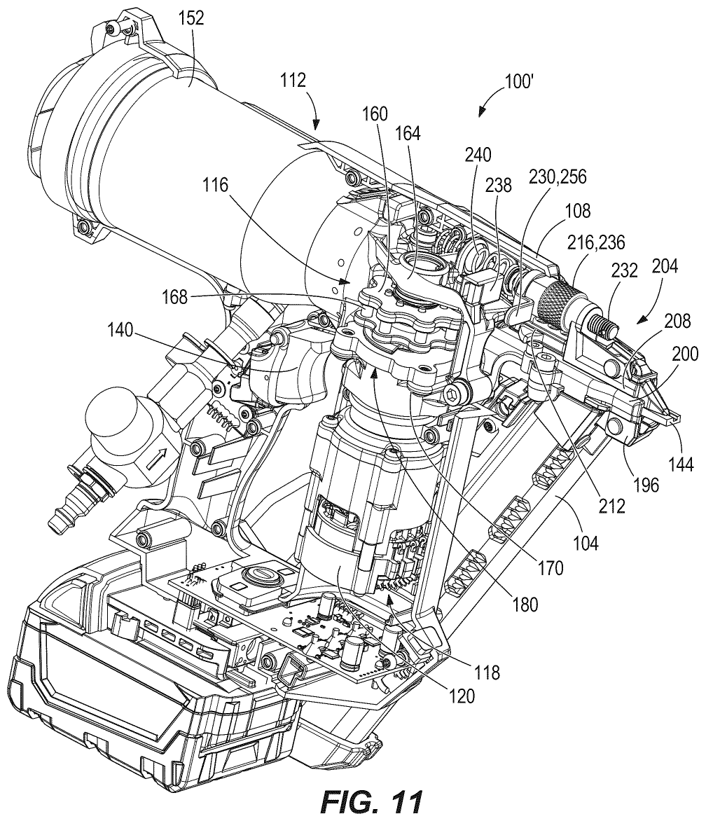

FIG. 1-4 and 10-11 illustrate a gas spring-powered fastener driver 100 in accordance with the present disclosure. FIGS. 1-2 illustrate a framing gas spring-powered fastener driver 100 and FIGS. 10-11 illustrate a metal connection gas spring-powered fastener driver 100'. The fastener drivers 100, 100′ are operable to drive fasteners (e.g., nails, tacks, staples, etc.) that are held within a magazine 104 into a workpiece (not shown). Although this application discusses the details of the powered fastener driver 100 of FIGS. 1-2, it should be understood that the powered fastener driver 100′ of FIGS. 10-11 include the same elements designated with the same reference numerals, unless otherwise discussed.

The fastener driver 100 includes a housing 108, illustrated as a two-piece clamshell housing, supporting a driving assembly 112 (FIG. 2) operable to drive a fastener and a lifting assembly 116 (FIG. 2) operable to reset the driving assembly 112, such that the fastener driver 100 can drive another fastener. The housing 108 includes a cylinder housing portion 110 and a motor housing portion 114 extending therefrom. The cylinder housing portion 110 is configured to support the driving assembly (or cylinder) 112, whereas the motor housing portion 114 is configured to support a drive unit 118. As shown in FIG. 2, the drive unit 118 includes an electric motor 120 and a transmission 124 positioned downstream of the motor 120. In addition, the illustrated housing 108 includes a handle portion 128 extending from the cylinder housing portion 110, and a battery attachment portion 132 coupled to an opposite end of the handle portion 128. A battery pack 136 is removably coupled to the battery attachment portion 132 and supplies electrical power to the drive unit 118. The handle portion 128 supports a trigger 140, which is depressed by a user to initiate a driving cycle of the fastener driver 100.

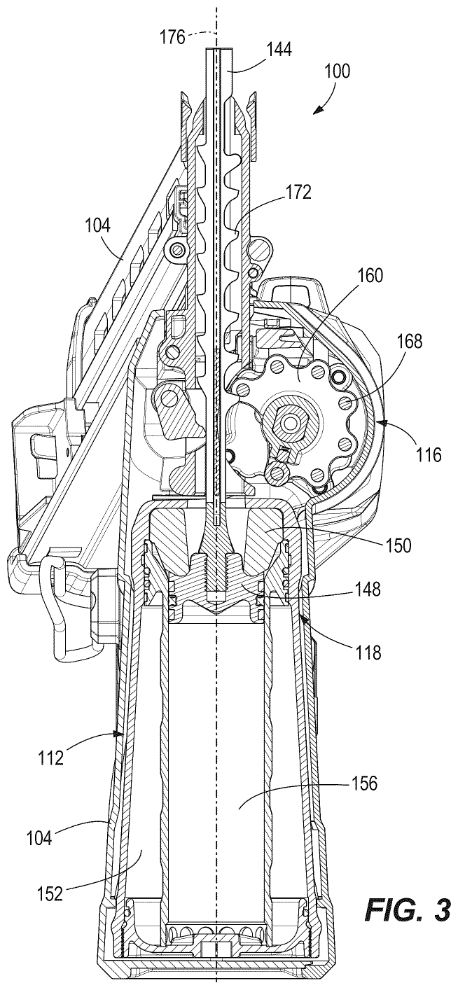

Now with reference to FIGS. 2 and 3, the driving assembly 112 includes a cylinder containing a pressurized gas, a drive piston 148 that is supported within the cylinder, and a driver blade 144 that is attached to the piston 148. The fastener driver 100 does not require an external source of air pressure, but rather includes an outer storage chamber cylinder 152 of pressurized gas in fluid communication with an inner cylinder 156. In the illustrated embodiment, the outer storage chamber cylinder 152 encompasses the inner cylinder 156, and together the outer storage chamber cylinder 152 and the inner cylinder 156 form a compression chamber. As the driver blade 144 and the piston 148 move toward a top-dead-center (TDC) position within the inner cylinder 156, the air within the compression chamber (e.g., above the piston 148) is compressed, thereby increasing an amount of pressure acting on the piston 148.

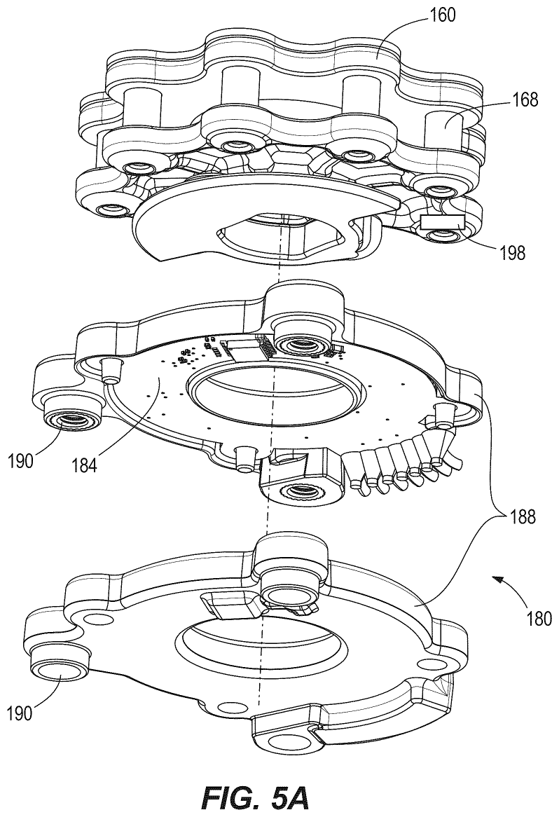

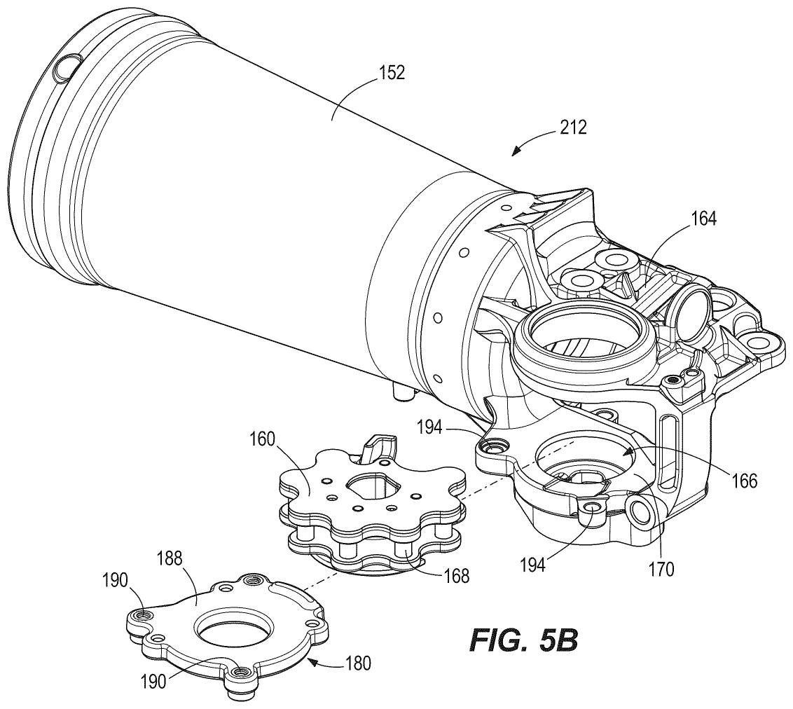

The lifting assembly 116 includes a rotary lifter 160 supported within the housing 108 by a frame 164 (FIG. 2) integrally formed with the outer storage chamber cylinder 152. In other words, the frame 164 and the outer storage chamber cylinder 152 are formed as a single piece. The frame 164 includes a flange 170 (FIG. 5B) that extends from the outer storage chamber cylinder 152 from which the rotary lifter 160 is at least partially rotatably supported. In the illustrated embodiment, the frame 164 defines a receiving aperture 166 (FIG. 5B) that is sized to receive the lifter 160 such that rotary lifter 160 can be supported by the flange 170. In other embodiments, the frame 164 may be formed separate from the outer cylinder 152. The rotary lifter 160 includes a plurality of engagement members 168. In some embodiments, the engagement members 168 may be a pin and/or a pin and roller combination. The lifter 160 is supported on the frame 164 and receives torque from the drive unit 118, causing the lifter 160 to rotate. The lifter 160 and the drive unit 118 may be collectively referred to as the lifting assembly 116 (FIG. 2). As the lifter 160 rotates, the engagement members 168 sequentially engage lift teeth 172 formed on the driver blade 144 to return the driver blade 144 along a driving axis 176 from a bottom-dead-center (BDC) position within the inner cylinder 156 in which the drive piston 148 is seated against a bumper 150 (FIG. 3) toward the TDC position.

In operation, the drive unit 118 provides torque generated by the electric motor 120 to the rotary lifter 160, causing it to rotate. Rotation of the rotary lifter 160 moves the driver blade 144 from the BDC position toward the TDC position. Movement of the driver blade 144 and the piston 148 toward the TDC position compresses the gas contained within the compression chamber, thereby increasing an amount of pressure acting on the piston 148. To drive a fastener, the driver blade 144 is released from the rotary lifter 160 and moves toward the BDC position due to the pressure of the expanding gas acting on the piston 148. The compression chamber is a sealed environment and therefore acts as a gas spring on the piston 148. As the driver blade 144 moves toward the BDC position, the driver blade 144 contacts the fastener to drive the fastener into the workpiece.

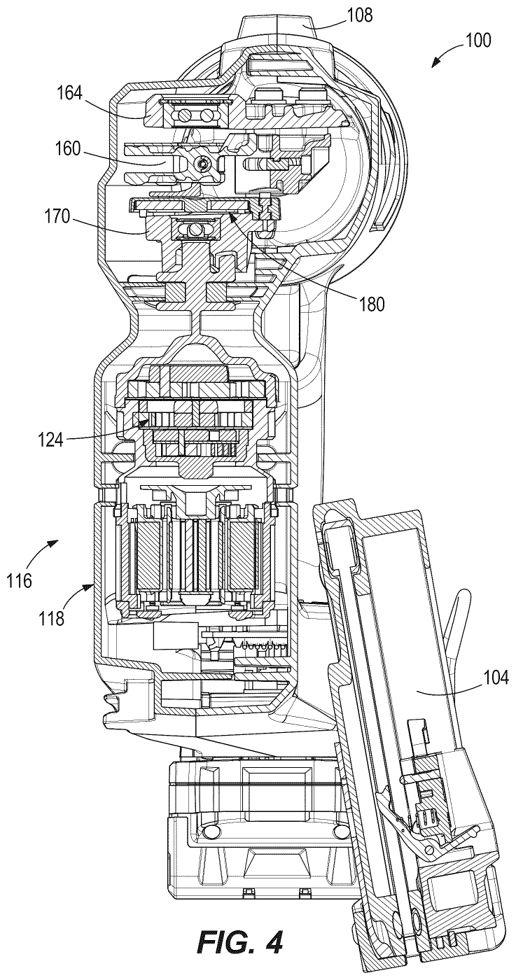

Referring to FIGS. 4, 5A, and 5B, the powered fastener driver 100 includes a lifter sensor assembly 180 positioned proximate the rotary lifter 160. The lifter sensor assembly 180 includes a lifter sensor 184 (FIG. 5A) and a lifter sensor bracket 188 coupled to the motor housing portion 114 proximate the rotary lifter 160. In the illustrated embodiment, the bracket 188 is coupled to the frame 164 such that the lifter sensor assembly 180 is positioned between the motor 120 and the rotary lifter 160 (FIG. 3). As shown in FIGS. 5A and 5B, the lifter sensor bracket 188 has a two-piece clamshell construction, which houses the lifter sensor 184 (FIG. 5A). For example, the lifter sensor bracket 188 includes a first shell and a second shell between which the lifter sensor 184 is enclosed. The bracket 188 further includes a plurality of mounting portions 190 that selectively align with corresponding mounting structures 194 formed on the flange 170. In the illustrated embodiment, the mounting portions 190 include an aperture that is sized to receive a fastener and a protrusion that aligns with a corresponding recess defined by the mounting structures 194.

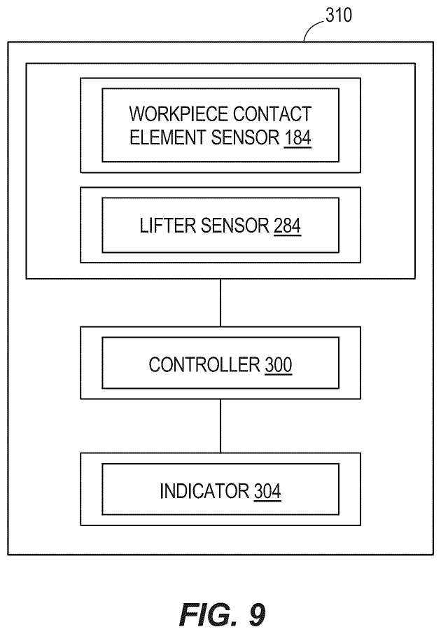

During assembly, the lifter sensor 184 is inserted within the lifter sensor bracket 188 and the two-pieces of the bracket 188 are coupled together. The lifter sensor assembly 180 is inserted within the receiving aperture 166 (FIG. 5B) defined by the frame 164 such that the mounting portions 190 are aligned with the mounting structures 194 on the flange 170. Fasteners (not shown) are inserted through the mounting portions 190 and are threaded to the mounting structures 194 to secure the lifter sensor assembly 180 to the flange 170. As such, the lifter sensor assembly 180 is fixed to the frame 164 such that the rotary lifter 160 rotates relative to the lifter sensor bracket 188 and the lifter sensor 184. In the illustrated embodiment, the lifter sensor 184 is an inductive sensor that detects a sensor target 198 (schematically illustrated in FIG. 5A) coupled for co-rotation with the lifter 160, and an electronic controller 300 (FIG. 9) is in communication with the lifter sensor 184. The sensor target 198 is configured to be sensed or detected by the inductive sensor (i.e., the lifter sensor 184). For example, inductive sensor may emit a magnetic field and the sensor target 198 may be a metallic or magnetizable element. When sensor target 198 approaches this magnetic field from the inductive sensor, the magnetic field is disrupted by the sensor target 198, which is detected by the lifter sensor 184. Therefore, it should be appreciated that the sensor target 198 may be a separate metal component coupled to the lifter 160 or a portion of the lifter 160 that is formed of a different material than the rest of the lifter 160.

The lifter sensor 184 and the sensor target 198 together define a lifter position sensing assembly that is configured to detect the angular position of the lifter 160. In other embodiments, the lifter sensor 184 may be an alternative non-contact sensor such as an optical sensor, a capacitive sensor, or a magnetic sensor. The lifter sensor 184 is configured to communicate with the controller 300 (FIG. 9) to control operation of the drive unit and/or detect faults in the power fastener driver 100 in response to the detected angular position of the lifter 160. For example, the controller 300 may deactivate the drive unit 118 if an abnormal lifter position is detected.

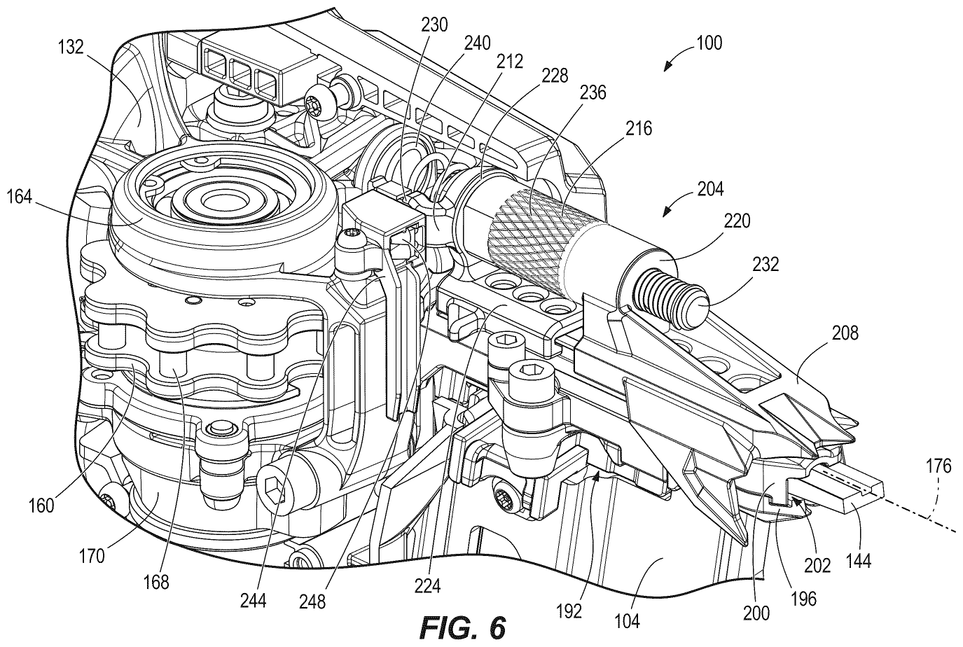

Now with reference to FIGS. 6-8, the powered fastener driver 100 further includes a nosepiece 192 supported by the frame 164. The nosepiece 192 includes a nosepiece base 196 and a nosepiece cover 200 coupled to the nosepiece base 196. The nosepiece base 196 is positioned at a front end (FIG. 1) of the magazine 104. The nosepiece cover 200 substantially covers the nosepiece base 196 (FIG. 6). The nosepiece base 196 and the nosepiece cover 200 define a fastener driving channel 202 therebetween from which consecutive fasteners from the magazine 104 are driven. The fastener driving channel extends along the driving axis 176.

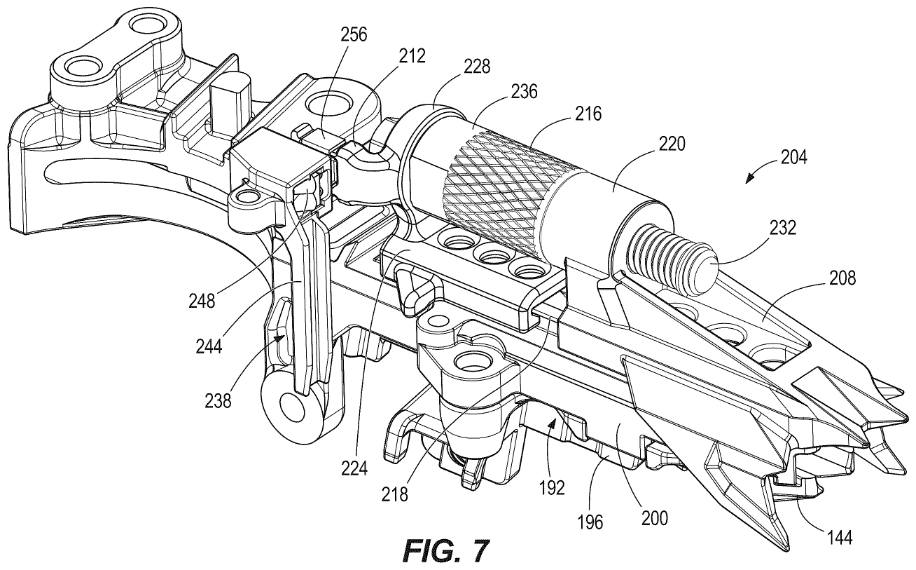

The powered fastener driver 100 further includes a workpiece contact element 204 supported by the nosepiece 192. The illustrated workpiece contact element 204 includes a lower portion 208 that is engageable with a workpiece and an upper portion 212. The lower and upper portions 208, 212 are movably coupled together by a depth of drive adjustment mechanism 216, which adjusts the effective length of the workpiece contact element 204. The lower portion 208 is slidably guided along the nosepiece 192. In particular, a top surface of the nosepiece cover 200 includes a rail 218 (FIG. 7) slidably engaged with a groove in the lower portion 208 of the workpiece contact element 204. In addition, the lower portion 208 includes a threaded boss 220 having internal threads.

The upper portion 212 of the workpiece contact element 204 includes a base 224, a flange 228 extending from the base 224 with which the depth of drive adjustment mechanism 216 is abutted, and a finger 230 extending upward from the flange 228. The base 224 also includes a groove that selectively engages the rail 218 to slidably support the upper portion on the top surface of the nosepiece base 196. In the illustrated embodiment, the upper portion 212 is slidable along the same rail 218 as the lower portion 208.

A biasing member (e.g., a compression spring) 240 (FIG. 6) is positioned between the frame 164 and the flange 228 to urge the workpiece contact element 204 toward an extended position relative to the nosepiece 192. The workpiece contact element 204 is movable relative to the nosepiece 192 between the extended position and a retracted position, in which the biasing member 240 is compressed. The workpiece contact element 204 moves from the extended position to the retracted position when the workpiece contact element 204 contacts a workpiece and a force directed toward the workpiece is applied by the fastener driver 100.

The depth of drive adjustment mechanism 216 includes a screw portion 232 and an adjustment knob 236. The screw portion 232 extends between the lower portion 208 and the upper portion 212 of the workpiece contact element 204. The threaded boss 220 of the lower portion 208 of the workpiece contact element 204 is threadably coupled to the screw portion 232. The adjustment knob 236 is coupled for co-rotation with the screw portion 232. Rotation of the adjustment knob 236 axially threads the lower portion 208 along the screw portion 232 for adjusting a protruding length of the workpiece contact element 204 relative to a distal end of the nosepiece 192. More specifically, rotation of the adjustment knob 236 moves the lower portion 208 relative to the upper portion 212 for adjusting an effective length of the workpiece contact element 204.

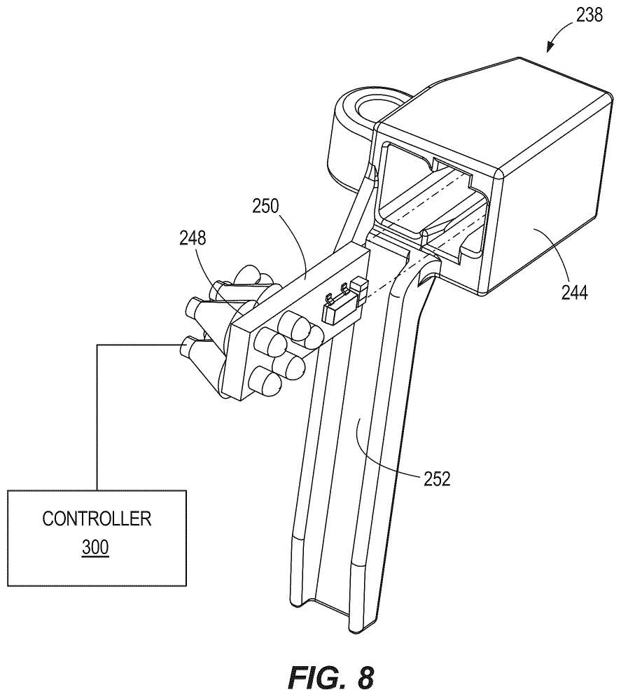

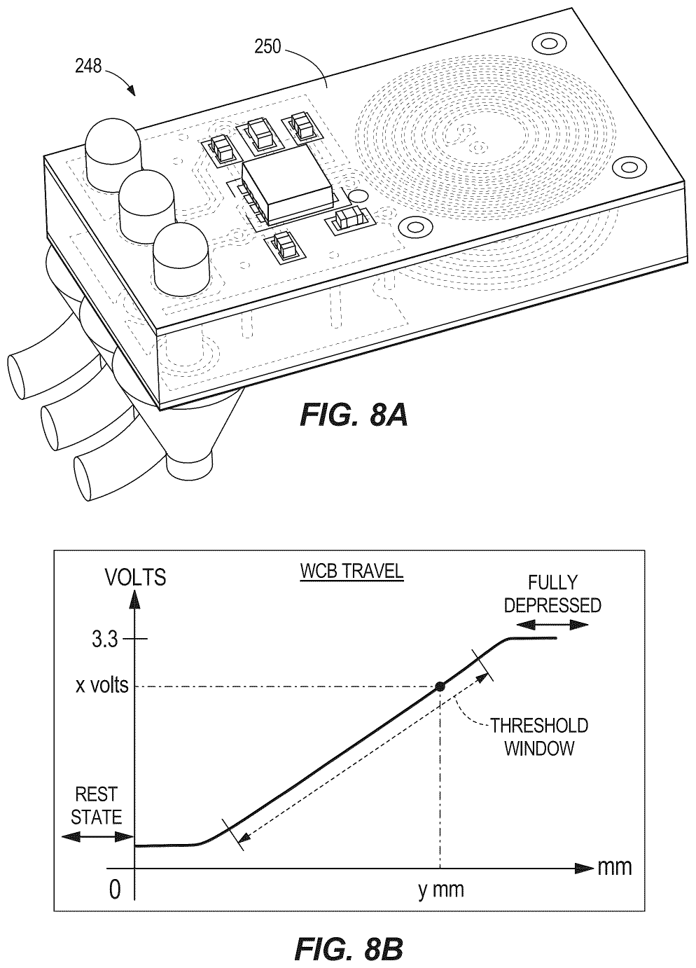

The powered fastener driver 100 further includes a workpiece contact element sensor assembly 238 (shown in detail in FIG. 8) positioned proximate the workpiece contact element 204. The workpiece contact element sensor assembly 238 includes a workpiece contact element sensor housing 244 coupled to the frame 164 and a workpiece contact element sensor 248 that is received within the housing 244. In the illustrated embodiment, the housing 244 is coupled to the frame 164 such that the workpiece contact element sensor 248 is positioned adjacent the finger 230 of the upper portion 212 of the workpiece contact element 204. Further, the workpiece contact element sensor assembly 238 is positioned in front of the lifter 160 (e.g., between the lifter 160 and an end of the nosepiece 192). The housing 244 further includes a wire guide 252 in which electrical wires extending between the sensor 248 and the controller 300 (schematically illustrated in FIG. 8) are routed and/or held captive.

The finger 230 defines a sensor target 256 (schematically illustrated in FIG. 7) that is configured to be sensed by the workpiece contact element sensor 248. In the illustrated embodiment, the workpiece contact element sensor 248 is an inductive sensor that detects the sensor target 256 coupled for movement with the workpiece contact element 204. For example, inductive sensor may emit a magnetic field and the sensor target 256 may be a metallic or magnetizable element. When sensor target 256 approaches this magnetic field from the inductive sensor, the magnetic field is disrupted by the sensor target 256, which is detected by the sensor 248. Therefore, it should be appreciated that the sensor target 256 may be the finger 230 itself or a separate metal slug or component coupled to the finger 230.

It should be appreciated that the sensor target may be coupled to any portion of the workpiece contact element 204 so the workpiece contact element sensor 248 can detect the sensor target. The workpiece contact element sensor 248 and the sensor target together define workpiece contact element sensor assembly 238 that is configured to detect a linear position of workpiece contact element 204 (e.g., along the driving axis 176). In particular, the workpiece contact element sensor 248 is configured to detect the sensor target to determine a position of the workpiece contact element 204 in the extended position or the retracted position. In the illustrated embodiment, the workpiece contact element sensor assembly 238 detects the workpiece contact element 204 in the retracted position shown in FIG. 7. In other embodiments, the lifter sensor 184 may be an alternative non-contact sensor such as an optical sensor, a capacitive sensor, or a magnetic sensor.

In operation of the fastener driver 100, the workpiece contact element sensor 248 provides an input signal to the controller 300 (FIG. 9) to control operation and/or detect faults in the powered fastener driver 100 in response to the detected position of the workpiece contact element 204. For example, the controller 300 may deactivate the drive unit 118, or prevent the drive unit 118 from activating, when the workpiece contact element sensor 248 determines that the workpiece contact element 204 is in the extended position. Additionally or alternatively, the controller 300 may deactivate the drive unit 118 when the workpiece contact element sensor 248 determines the workpiece contact element 204 is in the retracted position.

As illustrated in FIG. 9, the fastener driver 100 includes a control system 310 including the electronic controller 300, the lifter sensor 184, the workpiece contact element sensor 248, and an indicator 304 in communication with the controller 300. The controller 300 includes a plurality of electrical and electronic components that provide power, operational control, and protection to the components and modules within the controller 300 and/or the powered fastener driver. The indicator 304 may be exposed from an exterior of the housing 108 and may be configured as one or more of lights (e.g., a light-emitting diode or LED), a display panel, or the like. The controller 300 may selectively activate the indicator 304 to alert the operator that maintenance is required or a fault has occurred. For example, the controller 300 may deactivate the drive unit 118 and activate the indicator 304 when the lifter sensor 184 detects that the lifter 160 is in an abnormal lifter position (e.g., does not return to a ready position between the TDC and BDC positions due to a jammed fastener in the fastener driving channel 202 or the like). Additionally, or alternatively, the controller 300 may deactivate the drive unit 118 and activate the indicator 304 when the workpiece contact element sensor 248 determines that the workpiece contact element 204 is in an abnormal position (e.g., does not return to the extended position after being lifted from a workpiece).

In the illustrated embodiment, as shown in FIGS. 8A and 8B, the workpiece contact element sensor 248 is an analog sensor supported by a printed circuit board 250. The analog sensor has an operating voltage range. In the illustrated embodiment, the operating voltage range is 0.0V to 3.3V, while in other embodiments, the operating voltage range may be 0.0V to 5V or any other suitable voltage range. When the workpiece contact element is in the extended position and the workpiece contact element sensor 248 does not sense the sensor target 256, the workpiece contact element sensor 248 has a resting voltage. In the illustrated embodiment, the resting voltage is substantially zero (e.g., a lower value of the operating range). The term “substantially” as used herein means plus or minus 0.2. When the workpiece contact element is in the retracted position and the workpiece contact element sensor 248 does sense the sensor target 256, the workpiece contact element sensor 248 has a threshold voltage that is greater than the resting voltage. In some embodiments the threshold voltage may be substantially 3.3V (e.g., an upper value of the operating range). In other embodiments, the threshold voltage may be between the resting voltage and the upper value of the operating range. In the illustrated embodiment, the threshold voltage may be correlated to a minimum distance traveled by the workpiece contact element. Thus, a linear function can be used to correlate a minimum distance (e.g., in millimeters) required to be traveled by the workpiece contact element to the threshold voltage. In other words, the threshold voltage may be linearly proportional to the minimum distance traveled by the workpiece contact element for the sensor target 256 to be sensed by the workpiece contact element sensor 248.

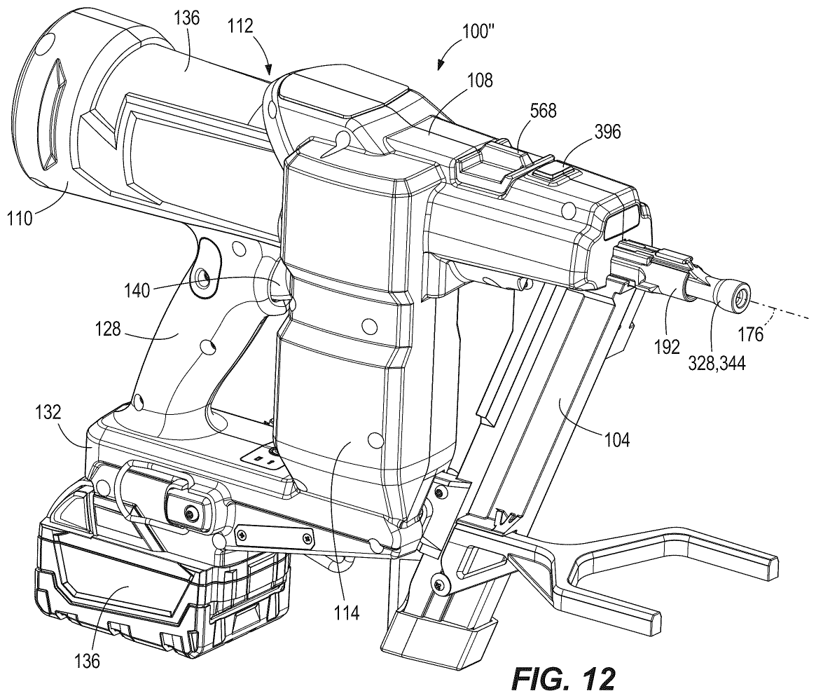

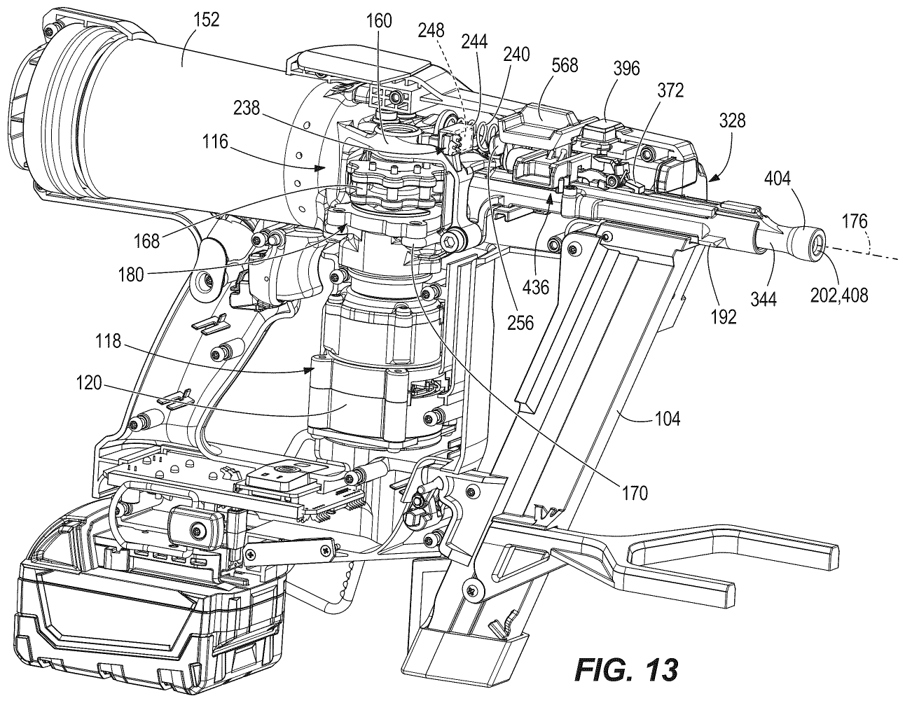

FIGS. 12-14 illustrate a gas spring-powered fastener driver according to another embodiment. In the illustrated embodiment, the gas spring-powered fastener driver is a concrete gas spring-powered fastener driver. The gas spring-powered fastener driver 100′ is operable to drive fasteners (e.g., nails, tacks, staples, etc.) that are held within a magazine 104 into a concrete workpiece (not shown). The gas spring-powered fastener driver 100′ is similar to the gas spring-powered fastener driver 100 of FIGS. 1-2, so the same elements are designated with the same reference numerals. The fastener driver 100′ has a different nosepiece and workpiece contact element configuration than the gas spring-powered fastener drivers 100, 100′.

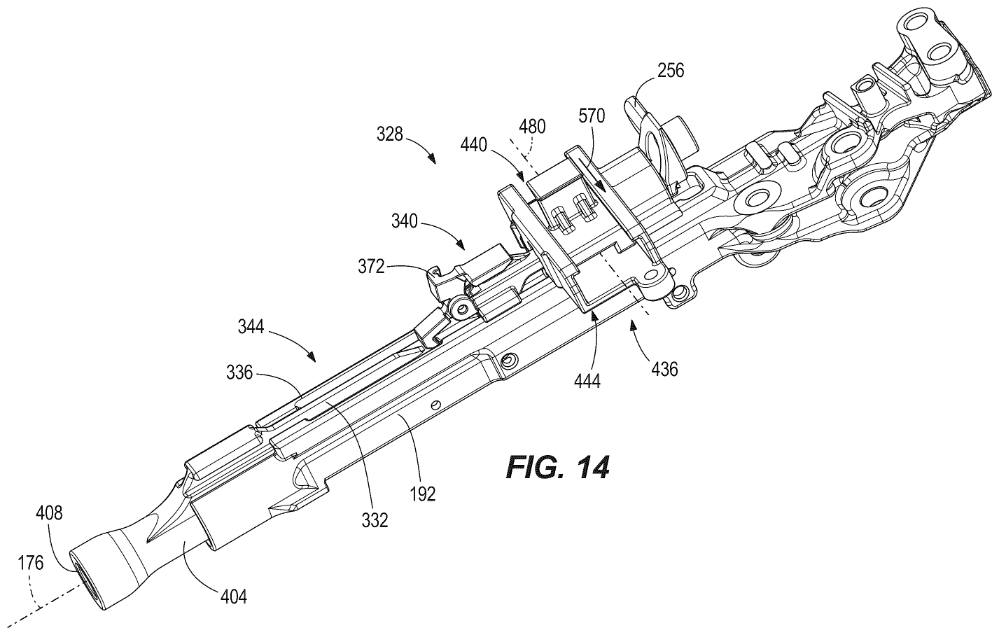

With reference to FIG. 14, the fastener driver 100′ includes a workpiece contact element 328 that is slidably engaged with the nosepiece 192. The nosepiece 192 includes an auxiliary channel 332 that is distinct from the fastener driving channel 202. In this case, the auxiliary channel 332 is positioned in front of the fastener driving channel 202. The auxiliary channel 332 is parallel to the fastener driving channel 202. A slot 336 extends through a wall of the nosepiece 192 and extends parallel to the auxiliary channel 332. The slot 336 is in communication to the auxiliary channel 332. The workpiece contact element 328 is at least partially received within and slidable relative to the auxiliary channel 332 and extends through the slot 336.

The workpiece contact element 328 includes an upper workpiece contact portion 340 and a lower workpiece contact portion 344 that is removably coupled to the upper workpiece contact portion 340. The workpiece contact element 328 is movable from an extended position to a retracted position when the lower workpiece contact portion 344 is in contact with the workpiece. A biasing member 240 (such as a compression spring) biases the workpiece contact element 328 into the extended position. In the illustrated embodiment, the workpiece contact element 328 (e.g., the upper workpiece contact portion 340) includes the sensor target 256, which operates in the same way as the sensor target 256 of the earlier embodiments. The lower workpiece contact portion 344 includes a barrel 404 with a channel 408 that partially defines the fastener driving channel 202.

A latch 372 removably couples the upper workpiece contact portion 340 to the lower workpiece contact portion 344. An actuator 396 is accessible from outside the housing 108 and is configured to move the latch 372 from the latched position, in which the upper workpiece contact portion 340 is coupled to the lower workpiece contact portion 344, to the released position, in which the upper workpiece contact portion 340 is coupled to the lower workpiece contact portion 344. Accordingly, the lower workpiece contact portion 344 may be removed from the upper workpiece contact portion 340. The user can then remove the lower workpiece contact portion 344 and replace it with another lower workpiece contact portion of a different size. For example, a first lower workpiece contact portion 344 having a barrel 404 with a channel 408 with a first inner diameter can be replaced by a second lower workpiece contact portion 344 having a barrel 404 with a channel 408 with a second inner diameter that is smaller or larger than the first inner diameter.

The fastener driver 100′ can fire a nail into a workpiece to a certain depth as determined by a depth adjustment assembly 436. The desired depth is determined by an effective length of the workpiece contact element 328 (e.g., a length of the second end of the lower workpiece contact portion 344 relative to a distal end of the nosepiece 192). The depth adjustment assembly 436 includes a shuttle 440 and a shuttle frame 444.

The shuttle frame 444 forms part of the workpiece contact element 328. That is, the shuttle frame 444 is forms part of the upper workpiece contact portion 340. The sensor target 256 is also coupled to the shuttle frame 444 adjacent to the first end. The biasing member 240 extends between the shuttle frame 444 and the frame 164. The biasing member 240 biases the shuttle frame 444, with the upper workpiece contact portion 340, toward the extended position. The shuttle frame 444 defines a shuttle axis 480 that is transverse to the driving axis 176. A shuttle 440 is movably supported by the shuttle frame 444 and slidable along the shuttle axis 480 to adjust the effective length of the workpiece contact element 328. The shuttle 440 is configured to be coupled to an actuator 568 that is accessible from outside of the housing 108. The actuator 568 is configured to be actuated by the user to slide the shuttle frame 444 along the axis of the shuttle 440, transverse to the driving axis 176.

As noted above, the shuttle frame 444 is part of the workpiece contact element 328 and the shuttle 440 is supported by the shuttle frame 444. Therefore, the shuttle frame 444, the shuttle 440, and the workpiece contact element 328 move in unison between the extended position and the retracted position. To adjust the depth of drive, the user uses the actuator 568 to laterally move the shuttle 440 along the shuttle axis 480 and transverse to the driving axis 176.

As the shuttle 440 moves, the upper workpiece contact portion 340 is adjusted relative thereto (as is the lower workpiece contact portion 344 since it is coupled thereto). For example, moving the shuttle 440 in a first direction of arrow 570 decreases the effective length of the workpiece contact element 328 and increases the depth to which the fastener is driven into the workpiece. In another example, moving the shuttle 440 in a second direction opposite the arrow 570 increases the effective length of the workpiece contact element 328 and reduces the depth to which the fastener is driven into the workpiece.

Various features of the invention are set forth in the following claims.

What is claimed is:

1. A powered fastener driver comprising:
a housing;
a cylinder within the housing, the cylinder containing a pressurized gas;
a piston within the cylinder and moveable from a top-dead-center position to a bottom-dead-center position;
a driver blade coupled to the piston for movement therewith and for driving a fastener into a workpiece, the driver blade having a plurality of teeth;
a rotary lifter rotatably supported within the housing and configured to sequentially engage the plurality of teeth to move the driver blade from the bottom-dead-center position toward the top-dead-center position;
a drive unit configured to provide torque to the rotary lifter, causing it to rotate;
a nosepiece defining a fastener driving channel from which consecutive fasteners from a magazine are driven, the fastener driving channel extending along a driving axis of the driver blade;
a workpiece contact element movable relative to the nosepiece between an extended position and a retracted position;
a first sensor target coupled for movement with the workpiece contact element;
a first sensor positioned forward of the rotary lifter and configured to detect the first sensor target to determine a position of the workpiece contact element in one of the extended position or the retracted position;
a second sensor target coupled for co-rotation with the rotary lifter; and
a second sensor positioned rearward of the rotary lifter and configured to detect an angular position of the rotary lifter.

2. The powered fastener driver of claim 1, wherein
the workpiece contact element includes a lower portion and an upper portion that is removably coupled to the lower portion,
the upper portion defines the first sensor target, and
the workpiece contact element includes a depth of drive adjustment mechanism having a shuttle that is movable along an axis that is transverse to the driving axis to adjust an effective length of the workpiece contact element.

3. The powered fastener driver of claim 1, wherein
the workpiece contact element includes a lower portion and an upper portion that is movable relative to the lower portion,
the upper portion defines the first sensor target, and
the workpiece contact element includes a depth of drive adjustment mechanism coupling the lower portion and the upper portion of the workpiece contact element to adjust an effective length of the workpiece contact element.

4. The powered fastener driver of claim 1, further comprising:
a frame supported within the housing and configured to support the rotary lifter; and
a sensor housing coupled to the frame in which the first sensor is received.

5. The powered fastener driver of claim 4, wherein the second sensor is coupled to the frame between the drive unit and the rotary lifter.

6. The powered fastener driver of claim 1, wherein each of the first sensor and the second sensor are inductive sensors.

7. The powered fastener driver of claim 1, wherein the first sensor is positioned forward of the driver blade.

8. The powered fastener driver of claim 1, further comprising an electronic controller in communication with the drive unit, the first sensor, and the second sensor, wherein the electronic controller is configured to control operation of the drive unit in response to the detected position of the workpiece contact element and the detected angular position of the rotary lifter.

9. A powered fastener driver comprising:
a housing;
a cylinder within the housing, the cylinder containing a pressurized gas;
a piston within the cylinder and moveable from a top-dead-center position to a bottom-dead-center position;
a driver blade coupled to the piston for movement therewith and for driving a fastener into a workpiece, the driver blade having a plurality of teeth;
a rotary lifter rotatably supported within the housing and configured to sequentially engage the plurality of teeth to move the driver blade from the bottom-dead-center position toward the top-dead-center position;
a drive unit configured to provide torque to the rotary lifter, causing it to rotate;
a nosepiece defining a fastener driving channel from which consecutive fasteners from a magazine are driven, the fastener driving channel extending along a driving axis of the driver blade;
a workpiece contact element movable relative to the nosepiece between an extended position and a retracted position;
a sensor assembly including
a first inductive sensor configured to detect a position of the workpiece contact element in one of the extended position or the retracted position;
a second inductive sensor configured to detect an angular position of the rotary lifter,
wherein the first inductive sensor and the second inductive sensor are on opposite sides of the rotary lifter.

10. The powered fastener driver of claim 9, wherein the first inductive sensor and the second inductive sensor are on opposite sides of the driver blade.

11. The powered fastener driver of claim 9, further comprising a frame supported within the housing and configured to support the rotary lifter and each of the first inductive sensor and the second inductive sensor.

12. The powered fastener driver of claim 9, wherein the workpiece contact element includes a lower portion and an upper portion that is coupled to the lower portion, and wherein the upper portion defines a first sensor target, the first inductive sensor configured to detect the position of the first sensor target.

13. The powered fastener driver of claim 12, wherein a threshold voltage of the first inductive sensor is linearly proportional to a minimum distance traveled by the workpiece contact element.

14. The powered fastener driver of claim 12, wherein the second inductive sensor is positioned between the drive unit and the rotary lifter and configured to detect a second sensor target coupled to the rotary lifter for rotation therewith.

15. The powered fastener driver of claim 9, further comprising an electronic controller in communication with the drive unit, the first inductive sensor, and the second inductive sensor, wherein the electronic controller is configured to control operation of the drive unit in response to the detected position of the workpiece contact element and the detected angular position of the rotary lifter.

16. A powered fastener driver comprising:
a housing;
a cylinder within the housing, the cylinder containing a pressurized gas;
a piston within the cylinder and moveable from a top-dead-center position to a bottom-dead-center position;
a driver blade coupled to the piston for movement therewith and for driving a fastener into a workpiece, the driver blade having a plurality of teeth;
a frame at least partially within the housing;
a rotary lifter rotatably supported by the frame and configured to sequentially engage the plurality of teeth to move the driver blade from the bottom-dead-center position toward the top-dead-center position;
a drive unit configured to provide torque to the rotary lifter, causing it to rotate;
a lifter sensor assembly configured to detect an angular position of the rotary lifter, the lifter sensor assembly including:
an inductive sensor coupled to the frame between the drive unit and the rotary lifter, and
a sensor target coupled for co-rotation with the rotary lifter.

17. The powered fastener driver of claim 16, wherein the frame includes an outer storage chamber cylinder in which the pressurized gas is stored and a flange extending from the outer storage chamber cylinder from which the rotary lifter is at least partially rotatably supported, and wherein the lifter sensor assembly includes a lifter sensor bracket having a plurality of mounting portions that are configured to align with corresponding mounting structures on the flange to secure the lifter sensor bracket to the frame.

18. The powered fastener driver of claim 17, wherein the lifter sensor bracket includes a first shell and a second shell between which the inductive sensor is enclosed.

19. The powered fastener driver of claim 17, wherein each of the plurality of mounting portions includes an aperture that is sized to receive a fastener and a cylindrical protrusion through which the aperture extends and that aligns with a corresponding recess defined by the corresponding mounting structures.

20. The powered fastener driver of claim 16, further comprising an electronic controller in communication with the drive unit and the lifter sensor assembly, wherein the electronic controller is configured to control operation of the drive unit in response to the detected angular position of the rotary lifter.
